(19) United States
(12) Patent Application Publication
(10) Pub. No.: US 2013/0105695 A1
(43) Pub. Date: May 2, 2013

(54) OPTICAL DEVICE USING BOTH VISIBLE AND INFRARED LIGHT

(71) Applicants: Jeong Yeol Han, Daejeon (KR); Kwang Dong Kim, Daejeon (KR); Jeong Gyun Jang, Daejeon (KR); Bi Ho Jang, Daejeon (KR)

(72) Inventors: Jeong Yeol Han, Daejeon (KR); Kwang Dong Kim, Daejeon (KR); Jeong Gyun Jang, Daejeon (KR); Bi Ho Jang, Daejeon (KR)

(73) Assignee: KOREA ASTRONOMY AND SPACE SCIENCE INSTITUTE, Daejeon (KR)

(21) Appl. No.: 13/578,536

(22) PCT Filed: May 2, 2012
(86) PCT No.: PCT/KR2012/003405

§ 371 Date: Aug. 10, 2012

(30) Foreign Application Priority Data
Oct. 26, 2011 (KR) 10-2011-0109888

(51) Int. Cl. G01J 5/08

(52) U.S. Cl. 250/353

(57) ABSTRACT

An optical device includes a body tube having an open end; a main reflector mounted to the other end opposite to the open end via an inner space of the body tube; a secondary reflector provided in the body tube to enable a light reflected by the main reflector incident thereon; a splitter arranged between the main reflector and the secondary reflector to enable a light reflected toward the inner space of the body tube by the secondary incident thereon, the splitter configured to divide the light incident thereon into a light at a visible wavelength range and a light at an infrared ray wavelength range; a visible ray analysis unit configured to read the light at the visible wavelength range incident from the splitter; and an infrared ray analysis unit configured to read the light at the infrared ray wavelength range incident from the splitter.

### TECHNICAL FIELD

The present invention relates to an optical device, more particularly, to an optical device using both visible (VI) and infrared (IR) light, which can improve a reading performance with respect to light at a visible ray region and light at an infrared ray region.

### BACKGROUND

Generally, an optical device having a lens and a reflector installed therein is used for a satellite or aerial camera capable of performing topography searching or an astronomical telescope capable of observing the stars.

Such an optical device includes a plurality of reflectors and lens that collect lights emitted from an object or celestial bodies to make lights observable or to make an auxiliary camera photograph lights. In certain circumstances, the optical device may use electronic data to image lights or to store lights.

Meanwhile, an optical device capable of reading a visible ray and an infrared ray simultaneously to enable an image visually precise and an object observable according to different wavelength ranges.

FIG. 1 is a diagram schematically illustrating inner components composing such a conventional optical device.

As shown in FIG. 1, a conventional optical device 1 includes a case 10 for defining an exterior appearance thereof and a cylindrical body tube 20 provided in the case 10. A main reflector 21 and a secondary reflector 23 are installed in the body tube 20.

The body tube 10 has an open end and the main reflector 21 is installed to the other end. The main reflector 20 is configured of a concave mirror and the secondary reflector 23 is installed to the open end of the body tube 10 to receive a light reflected by the main reflector 21 efficiently, as shown in the drawing.

A sub-reflector 25 is provided in the body tube 20 to receive a light reflected by the secondary reflector 23.

Meanwhile, a first prism 30 is provided outer to the body tube 20 to receive a light reflected by the sub-reflector 25. For that, the sub-reflector 24 and the first prism 30 may be inclined a predetermined angle with respect to a longitudinal direction of the body tube 20.

The first prism 30 is configured to divide the light incident via the sub-reflector 25 into lights at a visible wavelength range and lights at an infrared ray wavelength range.

The lights at the visible wavelength range divided by the first prism 30 may be transmitted to a visible ray casing 50 provided in the case 10, in communication with the body tube 20.

At this time, a plurality of condenser lens 52 may be provided in the visible ray casing 50 to condense lights and to be advantageous to the light-reading. An image sensor 54 such as a charge-coupled device (CCD) or a complementary metal oxide semiconductor field effect transistor (CMOS) is provided in the visible ray casing 50 to read the light at the visible wavelength range. In this instance, the terminology of “reading” means a process that enables data formation or image process.

The lights at the infrared ray wavelength range divided by the first prism 30 are incident on an infrared ray casing 60 provided in the body tube 10, in communication with the body tube 20. Information on the image may be read through a second prism 61, a group of condenser lenses 63 and the image sensor 65.

In the conventional optical device having the structure mentioned above, an auxiliary space is required in an outer portion to the body tube 20 to install the first prism 30 therein.

In addition, a structure for reading the lights at the visible wavelength range and the lights at the infrared ray wavelength range has to be installed in an outer portion to the body tube 20, with quite a longitudinal length. Accordingly, an overall size of the optical device has to be increased and spatial inefficiency might be caused.

Especially, the first prism 30 for dividing the light into visible rays and infrared rays is located on a passage distant from the main reflector 21 that receives the light initially. Also, the light is transmitted to the first prism 20 even after passing the secondary reflector 25. Accordingly, quite amount of light loss might be generated while the light is passing the passage to the first prism 30.

In addition, the lights divided by such the first prism 30 are transmitted to the infrared ray region via the secondary prism 61. Typically, when the lights are passing the prism, a random number difference of the lights happens to be severe. Even if the severe random number difference is compensated by an auxiliary lens, the image finally read cannot help but be affected badly.

Especially, the disadvantages mentioned above may cause a further disadvantage of deteriorating a modulation transfer function (MTF) that quantitatively means a value that is able to be read at a position distant from a reading object.

### DISCLOSURE

### Technical Problem

To solve the problems, the present invention is directed to an optical device.

An object of the present invention is to provide an optical device using both VI and IR that can be compact-sized.

Another object of the present invention is to provide an optical device using both VI and IR that is able to reduce light loss while lights are transmitted to enhance image reading and to enhance a MTF value.

### Technical Solution

To achieve these objects and other advantages and in accordance with the purpose of the embodiments, as embodied and broadly described herein, an optical device using both VI and IR includes a body tube formed in a circular drum shape, with an open end; a main reflector mounted to the other end in opposite to the open end via an inner space of the body tube; a secondary reflector provided in the body tube to enable a light reflected by the main reflector incident thereon; a splitter arranged between the main reflector and the secondary reflector to enable a light reflected toward the inner space of the body tube by the secondary incident thereon, the splinter configured to divide the light incident thereon into a light at a visible wavelength range and a light at an infrared ray wavelength range; a visible ray analysis unit provided in close contact with the body tube, the visible ray analysis unit configured to read the light at the visible wavelength range incident from the splitter; and an infrared ray analysis unit provided in close contact with the body tube, the infrared ray analysis configured to read the light at the infrared ray wavelength range incident from the splitter.

The main reflector may include a through hole provided in a center thereof, and the light reflected by the secondary reflector may pass through the splitter and travel via the through hole.

The splitter may reflect a visible ray and transmit an infrared ray.

The visible ray analysis unit may include a visible casing in communication with the body tube; a visible condenser lens group provided in the VI casing; and a visible auxiliary reflector provided in the VI casing to enable the light incident thereon to travel along an outer circumference of the body tube.

The infrared ray analysis unit may include an IR casing in communication with the body tube; an IR condenser lens group provided in the IR casing; and an IR auxiliary reflector provided in the IR casing to enable the light incident thereon to travel along an outer circumference of the body tube.

The main reflector comprises a through hole provided in a center thereof, and the optical device may further include an astigmatism compensator configured to primarily compensate an aberration of the light passing through the through hole.

In another aspect of the present invention, an optical device using both VI and IR includes a body tube formed in a circular drum shape, with an open end; a main reflector mounted to the other end in opposite to the open end via an inner space of the body tube; a secondary reflector provided in the body tube to enable a light reflected by the main reflector incident thereon; a splitter arranged between the main reflector and the secondary reflector to enable a light reflected toward the inner space of the body tube by the secondary incident thereon, the splinter configured to divide the light incident thereon into a light at a first wavelength range and a light at a second wavelength range; a visible ray analysis unit provided in close contact with the body tube, the visible ray analysis unit configured to read the light at the first wavelength range incident from the splitter; and an infrared ray analysis unit provided in close contact with the body tube, the infrared ray analysis configured to read the light at the second wavelength range incident from the splitter.

### Advantageous Effects

The embodiments have following advantageous effects.

First of all, according to the present invention, the auxiliary reflector and the condenser lens group are arranged along the lateral and rear portions of the body tube. Accordingly, the overall size of the optical device may be compact. Spatial utility may be enhanced and the operation of the optical device may be easy such that errors may be reduced advantageously.

Second, the splitter according to the present invention is arranged between the main reflector and the secondary reflector. The image process is performed after the lights at the visible wavelength range and the infrared ray wavelength range separated via the splitter are transmitted. Accordingly, the overall passage of the lights traveling to the image sensor may be short and light loss may be reduced. As a result, more improved image realization may be enabled advantageously.

Finally, according to the present invention, the usage of the prism which could generate the aberration difference may be reduced and the auxiliary reflector may replace the prism. The auxiliary reflector may change the passage of the lights. Accordingly, image analysis efficiency may be enhanced advantageously.

### BRIEF DESCRIPTION OF THE DRAWINGS

Arrangements and embodiments may be described in detail with reference to the following drawings in which like reference numerals refer to like elements and wherein:

FIG. 1 is a diagram schematically illustrating a conventional optical device having a visible ray analysis unit and an infrared ray analysis unit according to the prior art;

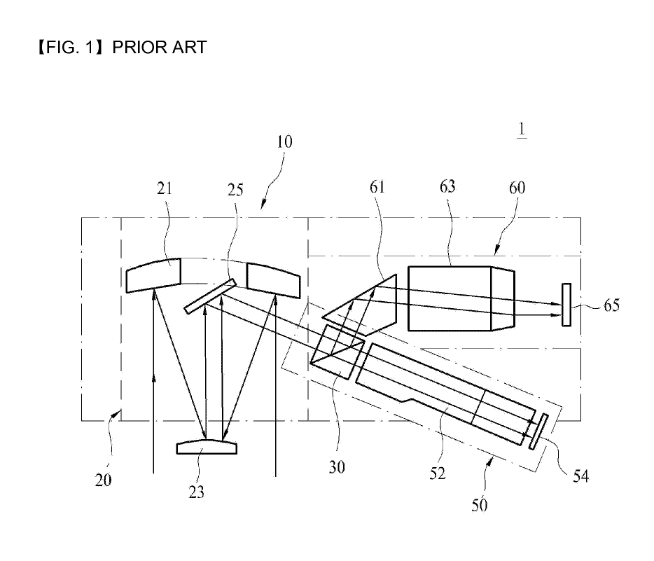

FIG. 2 is a perspective view illustrating an exterior appearance of an optical device according to the present invention, seen from the front;

FIG. 3 is a perspective view illustrating the optical device according to the present invention;

FIG. 4 is an exploded perspective view illustrating a visible ray analysis unit applied to the optical device according to the present invention; and

FIG. 5 is an exploded perspective view illustrating an infrared ray analysis unit applied to the optical device according to the present invention.

### BEST MODE

Embodiments will be described in detail to be embodied by those skilled in the art to which the embodiments pertain to, in reference to the accompanying drawings. Reference may now be made in detail to specific embodiments, examples of which may be illustrated in the accompanying drawings.

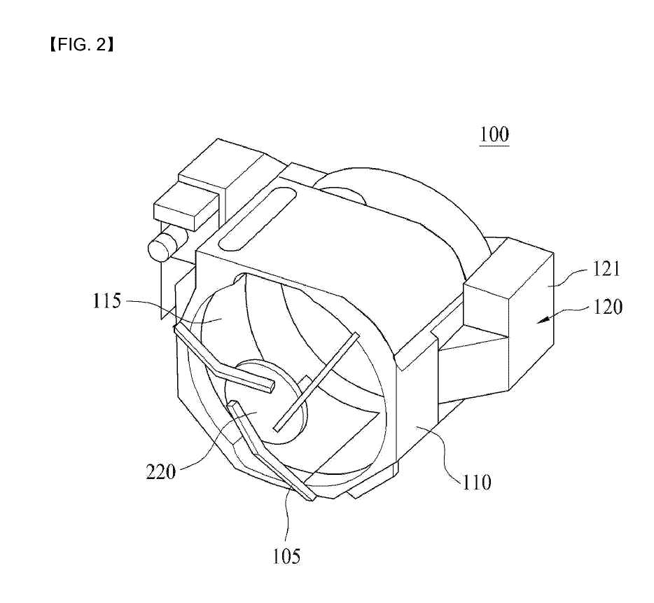

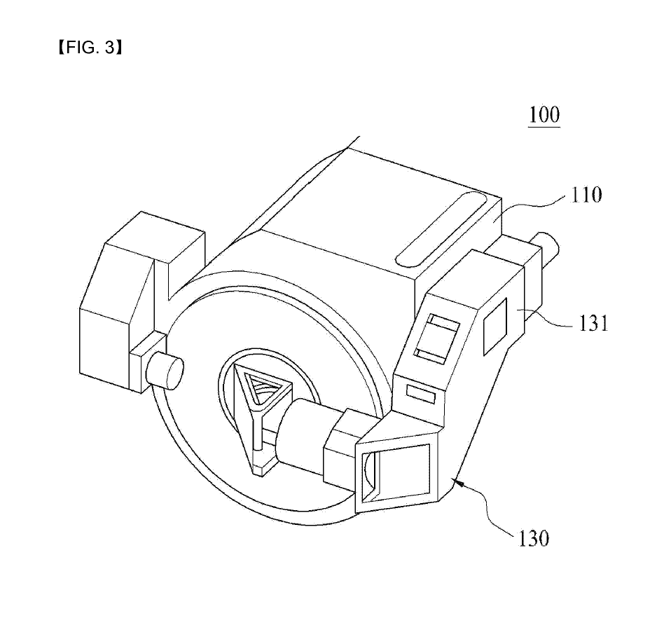

FIG. 2 is a perspective view illustrating an exterior appearance of an optical device according to the present invention, seen from the front. FIG. 3 is a perspective view illustrating the optical device according to the present invention;

As shown in FIGS. 2 and 3, the optical device 100 according to the present invention includes a body tube 110 for defining an exterior appearance thereof, a visible ray analysis unit 120 and an infrared analysis unit 130.

The body tube 110 forms a circular drum shape having an inner accommodation part. The visible ray analysis unit 120 is arranged to an outer lateral portion of the body tube 110 and the infrared ray analysis unit 130 is arranged to an outer rear portion of the body tube 110.

An opening 115 is provided in a front portion of the body tube 110 and an internal space of the body tube 110 is completely open. An VI casing 121 defining an exterior appearance of the visible ray analysis unit 120 and an IR casing 131 for defining an exterior appearance of the infrared ray analysis unit 130 are in communication with the body tube 110. In other words, communication portions (not shown) are provided in lateral and rear surfaces of the body tube, respectively, to communicate with the VI casing 121 and the IR casing 131.

Referring to the accompanying drawings, inner key parts of the optical device according to the present invention will be described in detail as follows.

Meanwhile, the visible ray analysis unit 120 and the infrared ray analysis unit 130 are mounted to one body tube 110 in the optical device according to the present invention. However, each of the analysis units will be separately shown and described for understanding and explanation convenience sake as follows.

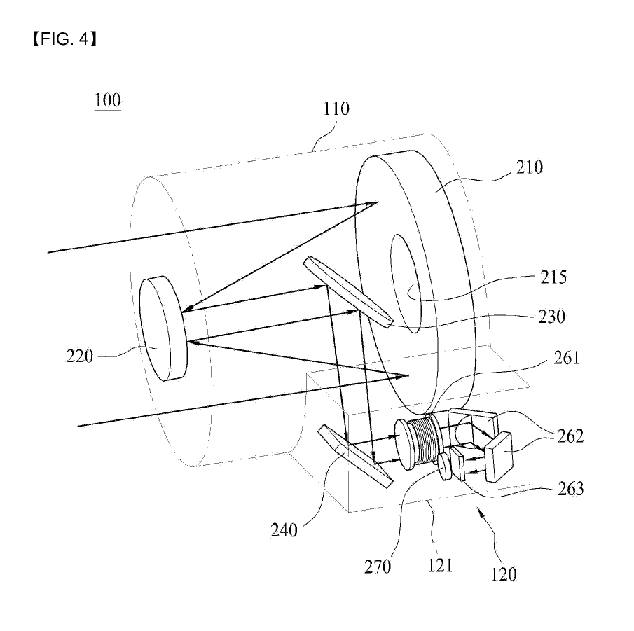

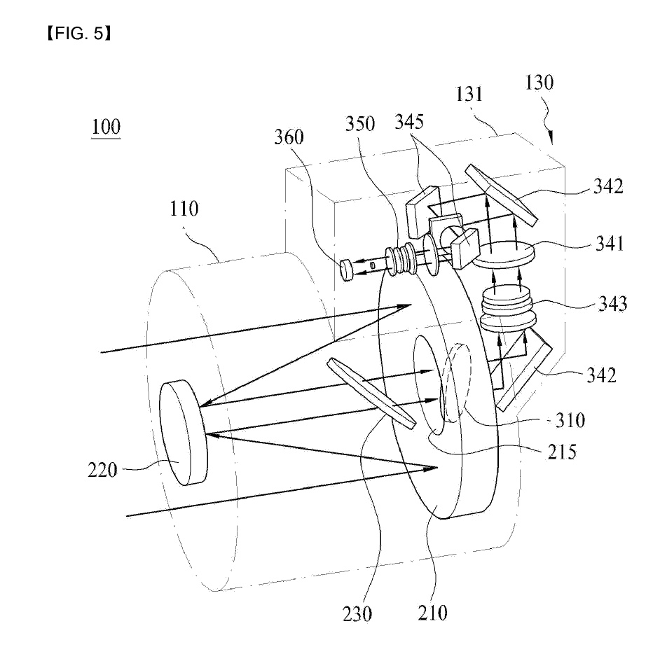

In the accompanying drawings, FIG. 4 is a perspective view illustrating a visible ray analysis unit applied to the optical device according to the present invention and FIG. 5 is a perspective view illustrating an infrared ray analysis unit applied to the optical device according to the present invention.

As shown in FIGS. 4 and 5, a main reflector 210 is installed in the other end of the body tube 110 in opposite to the opening 115. The size of the main reflector 210 may be substantially identical to an inner diagram of the body tube 110.

Preferably, a circumference of the main reflector 210 may be fitted airtight to an inner circumference of the body tube 110, to enable lights transmitted into the body tube 110 to be incident on the main reflector 210 without light loss.

The main reflector 210 includes a through hole 215 formed in a center thereof and the through hole 215 has a predetermined diameter that is approximately identical to a diameter of a secondary reflector 220. The through hole 215 forms a passage of lights at an infrared ray wavelength range, which will be described later.

The main reflector 210 may be configured of a concave mirror having a predetermined curvature enough to reflect the lights transmitted into the body tube 110 toward the opening 115 spaced apart a predetermined distance from the main reflector 210.

Meanwhile, the secondary reflector 220 is installed in the opening 115 of the body tube 110 to enable the lights reflected by the main reflector 210 incident thereon. The secondary reflector 220 may and it may have a predetermined curvature to be effective in transmitting lights to a splitter 230, which will be described later, efficiently and in condensing lights easily. At this time, the diameter of the secondary reflector 220 is determined to make more lights incident on an outer circumference portion of the main reflector 210 and simultaneously to make lights reflected toward the splitter 230 efficiently.

Referring to FIGS. 2 and 3, a first connection rod 105 is provided to couple the secondary reflector 220 to the body tube 110.

At least one first connection rod 105 is provided. An end of the first connection rod 105 is coupled to the body tube 110 and the other end of the first connection rod 105 is coupled to the secondary reflector 220.

In this instance, the position of the first connection rod 105 is determined to enable more lights to be incident on the main reflector 210 as possible and to reduce the movement of the secondary reflector 220 in various circumstances such as external vibration, temperature change and so on.

As shown in the drawings, two or more first connection rods 105 formed as thin as possible may be applied in order to position the secondary reflector 220 outer to the body tube 110 in a stable structure.

Referring to FIG. 4 again, the splitter 230 may be provided in the body tube 110 and it is positioned between the main reflector 210 and the secondary reflector 220 to enable the lights reflected by the secondary reflector 220 to pass there through. For that, the splitter 230 may be installed in the body tube 110 by a second connection rod (not shown) provided in the body tube 110. Even in this instance, the size of the second connection rod is determined to be smaller than the size of the secondary reflector to enable a sufficient amount of lights incident on the main reflector 210 and to prevent undesired lights from being incident on the main reflector 210. Also, the second connection rod has to be installed to reduce the movement of the splitter as much as possible even in changeable environments such as external vibration, temperature change and so on.

Although not shown specifically, the second connection rod is connected to the through hole 215 of the main reflector 210 to secure a sufficient space between the main reflector 210 and the secondary reflector 220. The second connection rod may be formed of a material incapable of reflecting lights.

The splitter 230 may enable lights at a visible wavelength range to be reflected and lights at an infrared ray wavelength range to be transmitted. The splitter 230 may be formed of a predetermined material or coated with a predetermined material. Such the splitter is well-known to anyone skilled in the art to which the present invention pertains and detailed description about the splitter will be omitted accordingly.

Meanwhile, the visible ray analysis unit 120 and the infrared ray analysis unit 130 perform image and data formation of the lights at the visible wavelength range and the infrared ray wavelength range, respectively, which are divided while lights are passing the splitter 230. The configurations of the visible ray analysis unit and the infrared ray analysis unit will be described as follows.

First of all, the visible ray analysis unit 120 includes a VI casing 121, a VI condenser lens group 261, a VI auxiliary reflector 240 and 262 and a VI image sensor 270.

The VI casing 121 is provided on a lateral portion of the body tube 110 and it is in communication with the lateral portion of the body tube 110 to enable the lights reflected via the splitter 230 to be incident thereon.

The VI condenser lens group 261 is configured to ease the reading of visible rays that are incident on the inner space of the VI casing 121.

The VI auxiliary reflector 240 and 262 is configured to adjust a passage of the visible rays to enable the visible rays to travel as close to the lateral portion of the body tube 110 as possible. For that, a plurality of auxiliary reflectors 240 and 262 may have adjustable sizes and positions. Accordingly, the traveling lights can have the shortest passage to the VI image sensor 270, with being as close as possible to an outer portion of the body tube 110.

Hence, referring to FIG. 5, the infrared ray analysis unit 130 includes an IR casing 131, an IR condenser lens group 343 and 350, an IR auxiliary reflectors 342 and 345 and an IR image sensor 360.

The IR casing 131 is provided on a rear portion of the body tube 110 to enable the lights passing the splitter 230 to be incident thereon. More specifically, after they incident on the main reflector 210 are reflected to be incident on the secondary reflector 220, the lights are re-reflected by the secondary reflector 220 and lights at the infrared ray wavelength range are separated from the lights passing the splitter 230. at this time, the lights at the infrared ray wavelength range having passed the splitter 230 are directly transmitted to the rear portion of the body tube 110 via the through hole 215 formed in the center of the main reflector 210. For that, the IR casing 131 is in communication with the rear portion of the body tube 110. Similar to the visible ray analysis unit 120, the infrared ray analysis unit 130 includes the group of the IR condenser lenses 343 and 350 and the plurality of the IR auxiliary reflectors 342 and 345 for adjusting a passage of the lights, such that the lights may be transmitted to the IR image sensor 360 via the IR condenser lens group and the IR auxiliary reflectors.

In other words, the VI auxiliary reflectors, the IR auxiliary reflectors 342 and 345 enable the lights to have the shortest passage to the VI image sensor along the rear and lateral portions. The VI image sensor may enable image analysis.

Meanwhile, each of the VI image sensor and the IR image sensor 360 may be a charge-coupled device (CCD) or a complementary metal oxide semiconductor field effect transistor (CMOS).

A numeral reference of “310” with no description is an astigmatism compensator configured to primarily compensate an aberration of the light incident on the infrared ray analysis unit 130. The astigmatism compensator is installed on the passage of the lights passing through the through hole 215 of the main reflector 210.

An operation process of the optical device using both VI and IR having the configuration mentioned above will be described according to an embodiment of the present invention as follows.

First of all, the light is transmitted into the body tube 110 via the opening and it is incident on the main reflector 210. The main reflector 210 may re-reflect the light incident thereon toward the secondary reflector 220 according to a radius of curvature.

After that, the secondary reflector 220 may reflect the light toward the splitter 230. The splitter 230 reflects to transmit the light at the visible wavelength range to the visible ray analysis unit 120 and transmits the light at the infrared ray wavelength range to the infrared ray analysis unit 130.

The lights transmitted to the VI casing 121 passes the plurality of the VI auxiliary reflectors 240 and 262 to travel along an outer lateral portion of the body tube 110. Finally, the lights traveling along the outer portion of the body tube 110 are converted into an image or a predetermined data or stored by the VI image sensor 270.

Similarly, the lights transmitted to the IR casing 131 passes the plurality of the IR auxiliary reflectors 342 and 345 to travel along outer rear and lateral portions of the body tube 110. Finally, the lights traveling along the outer and lateral portions of the body tube 110 are converted into an image or predetermined data or stored by the IR image sensor 360.

Accordingly, the user may acquire information on an observation object via data formation or imaged screen enabled by the lights at two different wavelength ranges.

Meanwhile, as mentioned above, the visible ray analysis unit 120 and the infrared ray analysis unit 130 are provided along a circumference of the body tube 110. Accordingly, the overall size of the optical device may be compact.

In addition, the splitter 230 is installed between the main reflector 210 and the secondary reflector 220, only to reduce loss of the lights while the lights are transmitted to the splitter 230 from the inside of the body tube 110. Accordingly, there may be an effect of enhancing the image quality.

Moreover, the auxiliary reflectors may replace the prism which could generate the aberration difference and it may change the passage of the lights. Accordingly, there may be enhanced image analysis efficiency.

Especially, the structure and effects mentioned above may enhance the modulation transfer function (MTF) value that quantitatively means a value that is able to be read at a position distant from a reading object.

Meanwhile, the light may be divided into not only the light at the visible wavelength range and a light at the infrared ray wavelength range but also a light at another predetermined wavelength range. According to the embodiment mentioned above, the optical device can image the light at the visible wavelength range and the light at the infrared ray wavelength range for understanding and explanation convenience sake. However, the light at the visible wavelength range or near infrared ray wavelength range may be imaged by an visible (VI) sensor and a light at the other wavelength range may be imaged by an auxiliary infrared image sensor.

In other words, a visible ray analysis unit according to one embodiment may analyze the light at the other wavelength range as well as the light at the visible wavelength range. As occasion demands, lights at predetermined wavelength ranges, for example, lights at a first wavelength range and a second wavelength range are separated to analyze them into an image.

It will be apparent to those skilled in the art that may be various modifications and variations the mobile terminal having the connection unit described above can be made in the present invention without departing from the spirit or scope of the inventions. Thus, it is intended that the present invention covers the modifications and variations of this invention provided they come within the scope of the appended claims and their equivalents.

1. An optical device using both visible (VI) and infrared (IR) light, comprising:
a body tube formed in a circular drum shape, with an open end;
a main reflector mounted to the other end in opposite to the open end via an inner space of the body tube;
a secondary reflector provided in the body tube to enable a light reflected by the main reflector incident thereon;
a splitter arranged between the main reflector and the secondary reflector to enable a light reflected toward the inner space of the body tube by the secondary incident thereon, the splitter configured to divide the light incident thereon into a light at a visible wavelength range and a light at an infrared ray wavelength range;
a visible ray analysis unit provided in close contact with the body tube, the visible ray analysis unit configured to read the light at the visible wavelength range incident from the splitter; and
an infrared ray analysis unit provided in close contact with the body tube, the infrared ray analysis configured to read the light at the infrared ray wavelength range incident from the splitter.

2. The optical device using both VI and IR light according to claim 1, wherein the main reflector comprises a through hole provided in a center thereof, and
the light reflected by the secondary reflector passes through the splitter and travels via the through hole.

3. The optical device using both VI and IR light according to claim 1, wherein the splitter reflects an visible ray and transmits an infrared ray.

4. The optical device using both VI and IR light according to claim 1, wherein the visible ray analysis unit comprises,
a VI casing in communication with the body tube;
a VI condenser lens group provided in the VI casing; and
a VI auxiliary reflector provided in the VI casing to enable the light incident thereon to travel along an outer circumference of the body tube.

5. The optical device using both VI and IR light according to claim 1, wherein the infrared ray analysis unit comprises,
an IR casing in communication with the body tube;
an IR condenser lens group provided in the IR casing; and
an IR auxiliary reflector provided in the IR casing to enable the light incident thereon to travel along an outer circumference of the body tube.

6. The optical device using both VI and IR light according to claim 5, wherein the main reflector comprises a through hole provided in a center thereof, and
the optical device further comprising:
an astigmatism compensator configured to primarily compensate an aberration of the light passing through the through hole.

7. An optical device using both VI and IR light, comprising:
a body tube formed in a circular drum shape, with an open end;
a main reflector mounted to the other end in opposite to the open end via an inner space of the body tube;
a secondary reflector provided in the body tube to enable a light reflected by the main reflector incident thereon;
a splitter arranged between the main reflector and the secondary reflector to enable a light reflected toward the inner space of the body tube by the secondary incident thereon, the splitter configured to divide the light incident thereon into a light at a first wavelength range and a light at a second wavelength range;
a visible ray analysis unit provided in close contact with the body tube, the visible ray analysis unit configured to read the light at the first wavelength range incident from the splitter; and
an infrared ray analysis unit provided in close contact with the body tube, the infrared ray analysis configured to read the light at the second wavelength range incident from the splitter.
